(19) United States
(12) Patent Application Publication
(10) Pub. No.: US 2025/0018602 A1
(43) Pub. Date: Jan. 16, 2025

(54) SYSTEMS AND METHODS FOR INCREASING MATERIAL FLUIDITY DURING TRANSIT

(71) Applicant: Building Machines, Inc., Hudson, MA (US)

(72) Inventors: Jeremy Samuel De Bonet, Southborough, MA (US); Nicholas Charles McMahon, Bolton, MA (US)

(21) Appl. No.: 18/707,860

(22) PCT Filed: Oct. 21, 2021
(86) PCT No.: PCT/US2021/056054

§ 371 Date: May 6, 2024

Related U.S. Application Data
(60) Provisional application No. 63/094,671, filed on Oct. 21, 2020.

(51) Int. Cl. B28C 5/48; B28B 1/093; B28B 17/00; B28B 17/02; B28C 7/02

(52) U.S. Cl. CPC B28C 5/48; B28B 1/0935; B28B 17/0081; B28B 17/02; B28C 7/024

(57) ABSTRACT

Systems and methods for increasing fluidity of a shear-thinning material during transit using an energizer which is coupled to a conveyance and configured to impart energy to the shear-thinning material as it is transported by the conveyance, thereby increasing the fluidity of the Material source Conveyor Form material. The conveyance may comprise any of a wide variety of transport means, including pumps, hoses or other conduits, conveyor belts, bins or buckets, chutes, hoppers, or the like. The energizer may use elements that generate mechanical vibrations, electromagnetic waves, acoustic waves, or the like to transfer energy to the shear-thinning material. The energy-imparting elements may be at a localized portion of the conveyance, or at multiple locations along a transport path of the conveyance, and may be controlled by a controller based on such parameters as sensed characteristics of the shear-thinning material or environmental conditions.

### RELATED APPLICATIONS

This application claims priority under 35 U.S.C. § 119(e) to U.S. Provisional Application No. 63/094,671, entitled “Method and System for Increasing Material Fluidity During Transit to Improve Consolidation When Forming”, filed Oct. 21, 2020, which is fully incorporated herein by reference for all purposes.

### TECHNICAL FIELD

Embodiments of the present invention relate generally to methods for facilitating the consolidation and transport of materials that are shear-thinning, thixotropic, or have other complex rheological properties, such as concrete, mortars, asphalt and other cementitious mixtures by imparting energy to the material while it is in the process of being conveyed to and/or deposited at a location where the material may set, cure, and/or take on its final properties.

### BACKGROUND

Materials with shear-thinning, thixotropic, or other complex rheological properties, in particular concrete, mortars, and other cementitious materials are often pumped, conveyed, or otherwise put into a form, mold, or final location where the material will harden.

When a cementitious material such as concrete is deposited (e.g., into a cavity within a form), it is typical that the concrete has air bubbles within the material, as well as air pockets that are formed against surfaces as the concrete fills a form. These voids and bubbles may reduce the strength of the concrete. Additionally, the concrete may not be homogeneous (e.g., the aggregate elements within the concrete may not be evenly distributed). This may create weak spots in the concrete. Further, if the concrete elements are not distributed across discrete pours or placements of the concrete, cold joints may be created. These problems may reduce the strength of the concrete, shorten its service lifetime, and create undesirable surface aesthetics. The greater the stiffness of the workable concrete as it is transported and poured (a property that is often desirous for many applications), the greater the extent of these problems.

Existing techniques include vibrating concrete in the form after it has been deposited. This improves the function and aesthetic of the concrete. Vibration causes the concrete to spread within the form, eliminating voids, filling the form, and allowing bubbles to escape from the concrete. Additionally, vibration helps the top surface of poured concrete to self-level to some degree. If the concrete is not properly consolidated, defects may be created which compromise the concrete strength and produce surface blemishes such as “bug holes” and “honeycombing.”

There are four main ways of consolidating concrete through vibration: 1) via an external vibrating element applied to the outside of the form; 2) via an internal vibrating element, often referred to as a “needle vibrator,” that is placed inside of the concrete within the form; 3) the concrete and form may be placed on a vibrating surface such as a vibration table; 4) via a surface or screed vibrator that applies vibrational energy to a top, exposed surface of unset material. Application of these techniques may be constrained by the type of concrete casting (e.g., a large concrete casting cannot be placed on a vibration table).

Although various methods involving vibration of the material after it has been pumped, placed, or injected into a form or mold are known, these known methods have some drawbacks. For instance, vibrating concrete using a needle vibrator is labor intensive, as it normally involves a laborer manually inserting the vibrator into the poured concrete at regularly spaced positions and vibrating the concrete for an interval that is sufficient to achieve proper consolidation. The quality of the process and the resulting quality of the concrete is often subject to the experience and diligence of the laborers.

### SUMMARY

The present disclosure details systems, methods and products for increasing the fluidity of shear-thinning material during transit by imparting energy to the material during the time it is being transported to a destination location to be deposited. One embodiment comprises a system for increasing fluidity of a shear-thinning material during transit, where the system includes a conveyance which is configured to transport a shear-thinning material from a material source to a destination, as well as an energizer which is coupled to the conveyance and configured to impart energy to the shear-thinning material as it is transported by the conveyance, the energy increasing the fluidity of the shear-thinning material.

The term “conveyance” is used herein to refer to the transport system that conveys the shear-thinning material from one point to another (e.g., from a concrete mixer to a concrete form), and may comprise any of a wide variety of transport systems, such as pumps, hoses or other conduits, conveyor belts, conveyor bins or buckets, chutes, hoppers, augers, or the like.

The energizer may be configured to impart the energy to the shear-thinning material in a localized portion of the conveyance, or it may be configured to impart the energy at multiple locations along a transport path of the conveyance. Those locations may be chosen to optimally generate shear within the material depending upon its particular rheological properties.

The energizer may be configured to impart the energy to the shear-thinning material via in any of a number of different ways, including but not limited to the use of mechanical vibrations, electromagnetic waves, acoustic waves, or other means of transferring energy to the shear-thinning material. In some embodiments, the energizer comprises a vibrator or vibrational member which is configured to generate vibrations at a designated frequency and amplitude, each of which may be independently or collectively variable. The energizer may comprise any of a number of different mechanisms, such as an electrically driven rotating eccentric mass, an acoustic wave generator, a hydraulically driven vibrator, a pneumatically driven vibrator, or the like.

In some embodiments, the conveyance includes an enclosure (e.g., a conduit, hopper or other substantially enclosed structure) through which the shear-thinning material is transported, and an energy propagation member (e.g., vibrator, acoustic wave generator, microwave generator, etc.) which is positioned within the enclosure so that the energy propagation member is substantially surrounded by the shear-thinning material as it is transported through the enclosure. The energy propagation member thereby imparts the energy directly to the shear-thinning material. The energy propagation member may alternatively be coupled to the exterior of the conveyance structure so that the energy is transferred through the conveyance structure to the shear-thinning material (for example, a vibrational element may be configured to vibrate the conveyance structure, which in turn vibrates the shear-thinning material within the structure).

In some embodiments, the system includes a controller which is coupled to the energizer, the controller providing one or more control signals to the energizer to adjust the rate at which the energy is imparted by the energizer to the shear-thinning material. The controller may be coupled to one or more sensors that sense one or more conditions or characteristics, generate sensor signals corresponding to the sensed conditions or characteristics, and provide the sensor signals to the controller, which then generates the control signals based on the received sensor signals. The sensed characteristics may, for example, comprise properties of the shear-thinning material, such as flowability, temperature, and moisture content. The sensed conditions may comprise environmental properties, such as ambient temperature or humidity. The controller may also be configured to receive one or more manual inputs from a user, the controller adjusting the output control signals based on the received manual inputs.

One alternative embodiment comprises a method for increasing fluidity of a shear-thinning material during transit. This method includes transporting a shear-thinning material from a material source to a destination and imparting energy to the shear-thinning material during transport, the energy increasing the fluidity of the shear-thinning material. Imparting the energy may comprise vibrating the shear-thinning material, applying microwave or other electromagnetic waves to the material, etc. The energy may be imparted to the shear-thinning material at a single location, or at a multiple, different locations in the transport path of the shear-thinning material, such as the delivery end of the transport path and at locations along the transport path which are between (intermediate to) the source and destination ends of the path. The closer the energy is applied to the point of use, the longer the thixotropic and shear-thinning effects will persist after the material has been deposited.

Numerous alternative embodiments may also be possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagram illustrating a system for depositing a shear-thinning material such as concrete in accordance with the prior art.

FIG. 2 is a diagram illustrating voids at an interface between layers of concrete that may result from the use of prior art techniques.

FIG. 3 is a diagram illustrating a system for depositing a shear-thinning material such as concrete in accordance with some embodiments.

FIG. 4 is a diagram illustrating two layers of concrete poured using the system of FIG. 3.

FIG. 5 is a diagram illustrating a method in accordance with some embodiments.

FIG. 6 is a diagram illustrating the structure of an example system in accordance with some embodiments.

FIGS. 7-10 are diagrams illustrating several different configurations of energizers in accordance with some embodiments.

FIG. 11 is a diagram illustrating a control system for controlling the energy imparted to a shear-thinning material as it is being transported in accordance with some embodiments.

FIG. 12 is a diagram illustrating a method for controlling energy imparted to shear-thinning material in a conveyance in accordance with some embodiments.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments disclosed herein teach new systems and methods for increasing the fluidity of materials that are shear-thinning, thixotropic, or of other complex rheological properties, such as concrete, mortars, asphalt, and other cementitious mixtures. These embodiments impart energy to the materials at one or more points during the transport of the materials, thereby increasing the fluidity of the materials and facilitating both the movement of the materials and the consolidation of the materials with previously deposited materials.

Embodiments of the invention may be used to transport various different types of materials that become more fluid as energy is imparted to the materials. “Shear-thinning” is used herein to refer to such materials. These materials include, but are not limited to cementitious mixtures such as concrete, mortar, asphalt, and variations thereof which may have special additives that increase the shear-thinning behavior of the material (commonly called “viscosity modifying admixtures”). The example embodiments provided below are focused on the transport of concrete, but these examples should be construed as illustrative of the invention, rather than limiting, and alternative embodiments may be used to transport and deposit other shear-thinning materials.

It should be noted that “concrete” is known to practitioners of the art to be a generic term for a mixture of materials that commonly include cement, aggregate, sand, water, and sometimes admixtures that are used to tune the properties of the concrete. By adjusting the proportions of any of the constituent materials, the resulting concrete's interstitial and final properties may change. These properties include but are not limited to final strength, air entrainment, consolidation, flow, etc. The techniques described below may apply to some but not all mixtures of concrete. The techniques will apply to concrete mixtures that exhibit shear thinning properties or are designed with shear thinning agents.

Increasing the fluidity of shear-thinning materials improves not only the transportability of the materials, but also the consolidation of the materials. Proper consolidation is a critical step in the use of such heterogeneous materials, as it optimizes the distribution of the constituent parts, eliminates pockets of air, and creates optimal material characteristics of the set and cured material including strength, water tightness, and aesthetic properties. The embodiments described in the present disclosure use techniques to impart energy into a shear-thinning material while it is in the process of being conveyed to or otherwise deposited at a location where the material will set, cure, and take on its final properties.

These embodiments use the shear-thinning properties of the materials to cause the viscosity of the material to decrease (i.e., to cause the fluidity or flowability of the material to increase) in response to the imparted energy. In some applications, the viscosity/fluidity/flowability may also depend on the rheological properties and the resultant time course of material stiffening after removal of the stimulus that imparts the energy to the material. By energizing the material while under conveyance, embodiments disclosed herein can be used to reduce or eliminate the need to vibrate the concrete after it is poured in order to achieve proper consolidation at its point of final use. The disclosed embodiments may be particularly suited to applications in which firm or “low slump” cementitious materials are transported via pumping, and where short term flowability is desirable to improve castability, and to eliminate voids and surface blemishes. It should be noted that “flowability” and “fluidity” may be used interchangeably herein.

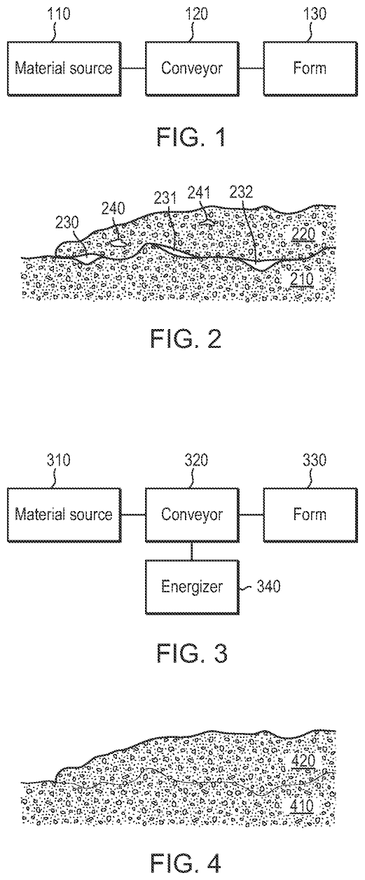

Referring to FIG. 1, a diagram illustrating a system for depositing a shear-thinning material such as concrete in accordance with the prior art is shown. In this figure, a shear-thinning material is provided by material source 110 to a conveyance 120. Conveyance 120 transports the material to a form 130, into which the material is deposited.

In this system, the components of the material (e.g., water, cement and aggregate) are mixed together at the material source and are provided to the conveyance. There are a number of different types of conveyances that are known in the art, such as chutes, pump systems, hoppers, augers, and the like. The conveyances used in the prior art do not normally intentionally affect the shear-thinning material. During the time the material is being transported by the conveyance, the amount of energy imparted on the material as a result of the mere transport is incidental, and generates a negligible amount of shear-thinning.

In many cases, the shear-thinning material that is transported by the conveyance system is deposited in multiple pours or batches. For instance, a first concrete truck may dump a first load of concrete into the hopper of a pump system that pumps the concrete to a form for a foundation or other large structure. When the concrete is deposited, it may form voids internally and where the concrete meets the surface of the form, so it is necessary to vibrate the concrete to eliminate these voids and to prevent weak areas and blemishes at the form surface.

After the first concrete truck is emptied, it will move and a second concrete truck may dump its load into the hopper of the pump, which will then transport this load of concrete to the form and deposit it in the form on top of the first layer of concrete from the first truck. When the second load of concrete is deposited in the form, it may again be sufficiently stiff that voids are created at the surface of the form, or between the layers of concrete. This is illustrated in FIG. 2.

As depicted in FIG. 2, a first layer of concrete 210 is poured, then a second layer of concrete 220 is poured on top of it. The stiffness of the concrete layers in this example leads to the formation of voids at the interface with a previous pour (230, 231, 232) or within the current pour (240, 241). If the freshly placed concrete is allowed to harden with these entrapped air voids, the concrete will be nonuniform, weak, porous, and poorly bonded to any reinforcement in the concrete. It will also typically have a poor appearance. Consolidation is therefore performed to reduce the voids and improve the strength and appearance of the concrete. Consolidation is a process in which the solid particles in freshly mixed concrete are caused to move into a closer arrangement, reducing the unwanted voids. Consolidation may be achieved in a number of ways, such as by vibrating, rodding, tamping, or centrifuging the concrete, or by performing some combinations of these actions. Consolidation may also be performed across separate pours or placements to cause the solid particles of the separate pours to be more closely arranged, providing increased strength of the concrete at the interface and avoiding “cold joints” between the layers.

In addition to the problems of voids and poor consolidation in the deposited material, the stiffness or limited flowability of the material may cause problems in the transport of the material from the source to the form. For instance, if the material is transported by pump, the stiffness may limit to the distance over which the material can be transported without forming clogs or obstruction in the transport path. This may be particularly true of concrete pumping systems in which concrete is forced by a pump through a hose or tube. This problem is aggravated by the fact that the material gradually stiffens even further over time, so longer transport paths and delays in the transport process can increase the likelihood of obstructions.

Referring to FIG. 3, a diagram illustrating a system for depositing a shear-thinning material such as concrete in accordance with some embodiments is shown. This system is similar to the system of FIG. 1, in that it includes a material source 310 and a conveyance 320 which transports material from source 310 to a form 330, into which the material is deposited. The system of FIG. 3 is distinct, however, in that it includes an energizer 340 which is coupled to conveyance 320, and is configured to impart energy to the shear-thinning material as it is transported by conveyance 320.

As a shear-thinning material such as concrete is transported by conveyance 320, the energy that is imparted by energizer 340 reduces the viscosity (increases the fluidity) of the material. The magnitude of the reduction is, to some extent, a function of the rheological properties of the material. In some embodiments, energizer 340 is configured to impart the energy to the material at a point which is near the end of the transport path from material source 310 to form 330. The increased fluidity of the material causes the material to more readily flow into and within the form. This, in turn, allows the material to flow into the areas that would, in the prior art, tend to form voids. This increases the strength of the material after it hardens and reduces the blemishes at the surface of the form.

The fluidity of the material resulting from imparting energy to the material in transit can also facilitate the consolidation of this material with volumes of material that were previously poured into the form. In order to achieve consolidation between the material of the different pours, it is still necessary to impart energy to the previously poured layer (e.g., by vibrating the material in the form with a form vibrator or stinger vibrator), but the time and energy required to do so is reduced because the subsequently poured layer has already been consolidated and is more fluid. As noted above, the consolidation of the material across layers causes the solid particles within the material to inter-mesh, increasing the strengthening the resulting structure and reducing the possibility of a cold joint between the layers.

Referring to FIG. 4, a diagram illustrating two layers of concrete poured using the system of FIG. 3 is shown. This diagram is provided to illustrate that the increased fluidity of the concrete which results from importing energy by the energizer to the concrete causes the more fluid concrete of the second layer (420) to flow into the areas that previously might have formed voids between the layers. Additionally, because the concrete deposited into the form has greater fluidity, the aggregate within the concrete can migrate across the interface between layers 410 and 420, increasing the strength of the combined pours.

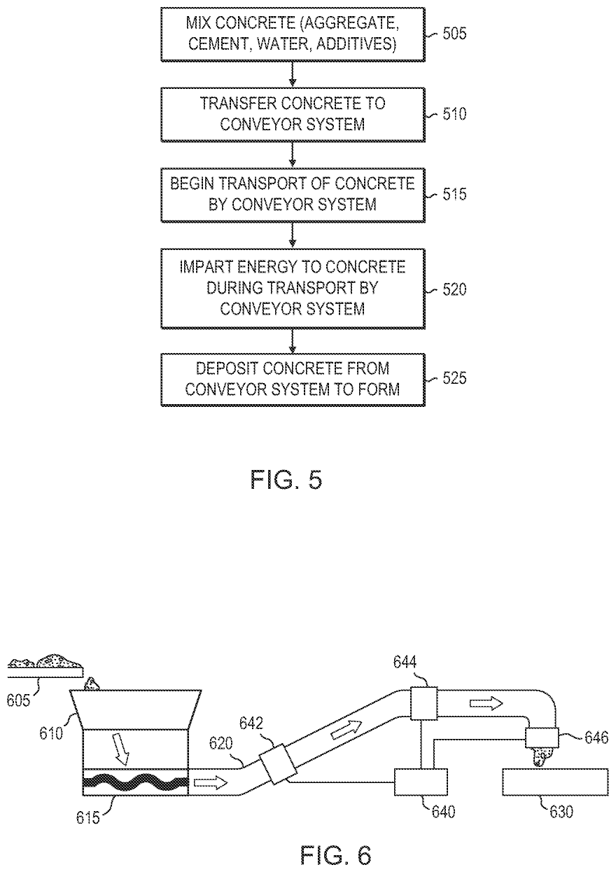

Referring to FIG. 5, a flow diagram illustrating a method in accordance with some embodiments is shown. In this example, the shear-thinning material is concrete, and the method begins with the mixing of the components (aggregate, cement, water, and any desired additives) to form the concrete (step 505). The concrete is then provided to a conveyance system (step 510) which is configured to transport the concrete from the source to a destination, such as a form into which the concrete will be poured. In some embodiments, the concrete may be mixed at a first location such as a concrete plant, loaded into a vehicle (a concrete truck), and transported by the vehicle to a conveyance system such as a concrete pump, chute, hopper, or the like which be used to transport the concrete to the form. The vehicle may or may not be considered part of the conveyance system.

Once the transport of the concrete by the conveyance system has begun (step 515), energy is imparted to the concrete as it is being transported (step 520). It should be noted that the imparting of the energy may occur while the concrete (or other shear thinning material) is physically stationary (e.g., while the concrete is simply being held in a bucket or hopper), or as the concrete is in motion along the transport path (e.g., while the concrete is being pumped through a conduit). The energizer may be configured to impart energy to the concrete at multiple points along the transport path. For the purposes of this disclosure, the concrete or other material will be considered to be “in transport” at any point along the transport path from the source of the material to its destination.

The energizer may be configured to impart energy to the shear-thinning material in various different ways. For example, in some embodiments, energy may be imparted to the material using vibrational elements. These vibrational elements may be positioned internally (i.e., within the shear-thinning material itself), or externally (i.e., coupled to the conveyance external to the conduit, chute, etc., where it does not come into direct contact with the shear-thinning material). The energizer may, for instance, comprise one or more rotating eccentric masses coupled to structures of the conveyance such as a hopper, or a discharge end of a hose or other conduit. Finally, the concrete is deposited from the conveyance system to the form or other final location where it is poured (step 525).

Referring to FIG. 6, a diagram illustrating the structure of an example system in accordance with some embodiments is shown. This figure is intended to illustrate one of the many embodiments that can be used to impart energy to the concrete (or other shear-thinning material) and to increase the fluidity thereof.

In the example of FIG. 6, concrete which is provided by a concrete source is conveyed via a chute 605 to a hopper 610 which feeds a concrete pump 615. Concrete pump 615 pumps the concrete into a hose 620, and the concrete flows through the hose to a form 630. An energizer system including a controller 640 and a set of vibrational elements 642, 644 and 646 is coupled to hose 620. Controller 640 controls vibrational elements 642, 644 and 646 to cause them to vibrate at desired frequencies and amplitudes. The vibration of these elements imparts energy to the concrete flowing through hose 620, causing the fluidity of the concrete to increase (i.e., causing the viscosity of the material to decrease). Sensors may be provided to measure various characteristics and/or conditions which are provided as inputs to controller 640. Controller 640 can then use these inputs to adjust the frequencies and/or amplitudes at which vibrational elements 642, 644 and 646 vibrate. Controller 640 thereby controls the amount by which the fluidity of the concrete is increased.

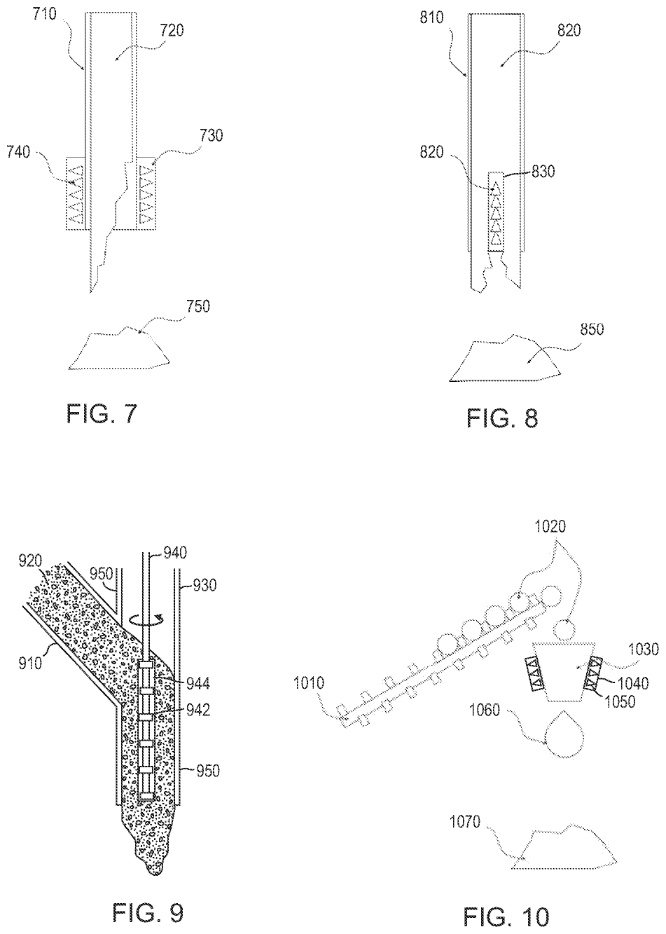

FIGS. 7-10 are diagrams illustrating several different configurations of energizers in accordance with some embodiments. FIG. 7 is an example of an energizer 730 that uses an external configuration at the end of a hose 710 through which concrete 720 is pumped. Energizer 730 includes a number of internal vibrational elements 740 which generate vibrational energy that is applied to the exterior of hose 710. This energy is then communicated through the hose-end to concrete 720 to increase the fluidity of the concrete just before it exits the hose and is deposited at a destination 750 (e.g., within a form).

FIG. 8 is another example of an energizer that is positioned at the end of a hose 810 for transporting the concrete 820. In this embodiment, energizer 830 is positioned within the end of hose 810, so that it is substantially completely surrounded by concrete 820. Thus, rather than radiating the vibrational energy from the exterior of the hose to the concrete within the hose, the vibrational energy is radiated from the center of the hose outward to the surrounding concrete. In both cases, elements 840 such as rotating eccentric masses can be used to generate the vibrational energy. As concrete 820 flows past energizer 830, the fluidity of the concrete is increased to improve the consolidation of the concrete in the form 850 (or in such other location as it may be deposited).

Referring to FIG. 9, an exemplary mechanism for generating vibrational energy within the end of a conduit is shown. In this example, a first conduit 910 through which concrete 920 flows merges with a second conduit 930. A rod or cable 940 extends through second conduit 930 into the merged portion 950 of the two conduits that forms an end of the concrete transport path. Rod/cable 940 is rotated, causing eccentric masses (e.g. 942) within needle vibration element 944 to vibrate, imparting energy to concrete 920 and increasing its fluidity just before it exits the conduit to be deposited in a form or other location. In some embodiments, multiple needle vibrators can be similarly positioned within the conduit, but with the vibration elements spaced apart to provide a more even distribution of the vibrational energy throughout the concrete which is flowing through the conduit.

It should be noted that the vibrational elements described in relation to the embodiments of FIGS. 7-10 can use different mechanisms for creating the vibrational energy, or may use alternatives other than vibration to impart energy to the flowing concrete. For instance, some alternative embodiments may use microwave generators to impart energy to the concrete.

Referring to FIG. 10, another alternative embodiment is disclosed. In this embodiment, a conveyor belt 1010 may transport portions of concrete 1022 a hopper 1030. An energizer 1040 is coupled to hopper 1030 and is configured to impart energy to the concrete flowing through the hopper. Energizer 1040 may, for example, use vibrational elements 1050 to generate the vibrational energy that is imparted to the concrete. The concrete that exits the hopper 1060 has increased fluidity due to the imparted energy, so that it has increased fluidity when it is deposited at the destination 1070 (e.g., in a form).

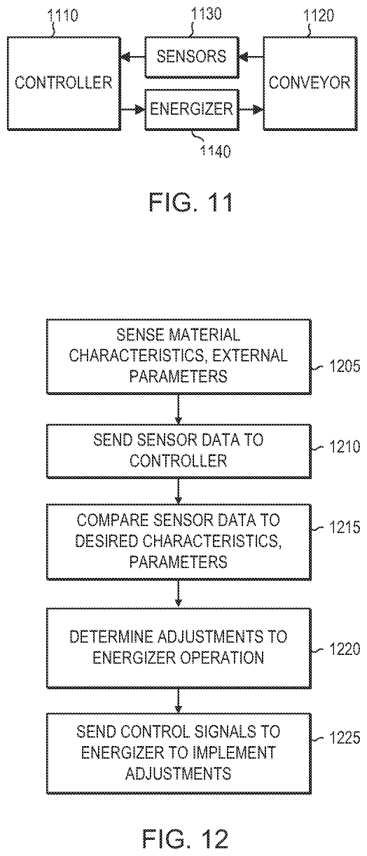

Referring to FIG. 11, a block diagram is shown illustrating a control system for controlling the energy imparted to the concrete (or other shear-thinning material) as it is being transported in accordance with some embodiments. In this embodiment, a controller 1110 is coupled to the conveyance system 1122 control the imparted energy. A set of sensors 1130 are positioned in, on, and/or around the conveyance to sense parameters that can be used by controller 1110 to determine the amount of energy that should be generated by energizer 1140.

Sensors 1130 may be configured to sense characteristics of the concrete that is being transported by conveyance 1120, such as the fluidity (or viscosity) of the concrete, the moisture in the concrete, the flow rate of the concrete, etc. These sensors may be internal to a conveyance conduit, or may be otherwise positioned so that they are in direct physical contact with the concrete (although some sensors may be capable of measuring some parameters such as temperature without direct contact with the concrete). Other versions of sensors 1130 may be configured to sense conditions other than characteristics of the concrete, such as ambient temperature, humidity, etc. which may affect the fluidity of the concrete. Sensors 1130 may be positioned at various locations along the flow path of the concrete.

Controller 1110 receives signals from sensors 1130 indicating the corresponding sensed characteristics and/or conditions, and uses these signals to determine whether these parameters are within desired ranges. Controller 1110 may be implemented in a computer or microprocessor that performs algorithms for the purpose of adjusting the energy based on sensor feedback. Controller 1110 may perform various computations to determine whether the energy that is being imparted to the concrete should be maintained, increased or decreased. Based on these computations, controller 1110 generates control output signals that are provided to energizer 1140. The control signals cause energizer 1140 to generate the necessary energy to achieve the desired fluidity of the concrete. The control signals may, for example, control the frequency and/or amplitude of vibrational elements that impart their energy to the concrete.

Controller 1140 may be configured to individually control energizer components at different locations along the flow path of the concrete, or it may control the energizer components collectively. This may include individually or collectively receiving sensor signals from one or more locations along the concrete flow path, and may include individually or collectively communicating control signals to energizer elements at different locations along the flow path.

Referring to FIG. 12, a flow diagram illustrating a method for controlling energy imparted to shear-thinning material on a conveyance in accordance with some embodiments is shown. In this embodiment, one or more parameters are sensed by sensors implemented in the conveyance system (step 1205). As noted above, these parameters may include characteristics of the shear-thinning material, such as fluidity or viscosity, moisture content, flow rate, etc., as well as ambient conditions, such as temperature and humidity. The information sensed by the sensors is transmitted to a controller (step 1210). In this embodiment, the sensor data input to the controller is compared to desired ranges for these parameters (step 1215) to determine whether the control outputs generated by the controller should be adjusted (step 1220). In various embodiments, the parameters may be used to compute the control signals to be output without explicitly comparing the parameters to the desired ranges. The controller then sends the generated control signals to the energizer (step 1225) to adjust the operation of the energizer (e.g., to adjust the frequency and/or magnitude of vibrational elements.

As noted above, alternative embodiments may include variations from the specific examples which are provided. For instance, embodiments may impart energy to materials other than concrete which exhibit shear-thinning and/or other complex rheological properties. The energy may be imparted at a single point (e.g., at the end of the conveyance where the material is discharged), or at multiple points along the flow path of the conveyance. The energy may be imparted using various types of energizer elements, such as vibrational elements, electromagnetic generators, acoustic generators, thermal generators etc. the energizer elements may be positioned in direct contact with the shear-thinning material within the flow path of the conveyance, or they may be external to the flow path so that they do not directly contact the material. The energizer elements may provide energy to the material at a constant rate, or they may be adjustable, either manually or automatically through the use of a controller system that uses sensor feedback.

The computer used for the controller may include, for example, a computer processor and associated memory. The computer processor may be an integrated circuit for processing instructions, such as, but not limited to a CPU. For example, the processor may comprise one or more cores or micro-cores of a processor. The memory may include volatile memory, non-volatile memory, semi-volatile memory or a combination thereof. The memory, for example, may include RAM, ROM, flash memory, a hard disk drive, a solid-state drive, an optical storage medium (e.g., CD-ROM), or other computer readable memory or combination thereof. The computer may also include input/output (“I/O”) devices, such as a keyboard, monitor, printer, electronic pointing device (e.g., mouse, trackball, stylus, etc.), or the like. The client computer system may also include a communication interface, such as a network interface card, to interface with the sensors, either directly or via a network.

Algorithms for determining the control outputs based on manual and sensor inputs can be implemented in the form of control logic in software or hardware or a combination of both. The control logic may be stored in an information storage medium, such as a computer-readable medium, as a plurality of instructions adapted to direct an information processing device to perform a set of steps of the control algorithm.

Based on the disclosure and teachings provided herein, a person of ordinary skill in the art will appreciate other ways and/or methods to implement the invention. Steps, operations, methods, routines or portions thereof described herein be implemented using a variety of hardware.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for increasing fluidity of a shear-thinning material during transit, the system comprising:
a conveyance configured to transport a shear-thinning material from a material source to a destination; and
an energizer coupled to the conveyance, the energizer imparting energy to the shear-thinning material as the shear-thinning material is transported by the conveyance, thereby increasing a fluidity of the shear-thinning material.

2. The system of claim 1, wherein the conveyance comprises one or more of the group consisting of a pump, a conduit, a conveyor belt, a chute, an auger, a flying bucket and a hopper.

3. The system of claim 1, wherein the energizer is configured to impart the energy to the shear-thinning material in a localized portion of the conveyance.

4. The system of claim 1, wherein the energizer is configured to impart the energy to the shear-thinning material at multiple locations along a transport path of the conveyance.

5. The system of claim 1, wherein the energizer is configured to impart the energy to the shear-thinning material via one of the group consisting of mechanical vibrations, electromagnetic waves, and acoustic waves.

6. The system of claim 1, wherein the energizer comprises a vibrator member which is configured to generate vibrations at a frequency and amplitude, wherein at least one of the frequency and the amplitude is variable.

7. The system of claim 1, wherein the energizer comprises a mechanism selected from the group consisting of an electrically driven rotating eccentric mass, an acoustic wave generator, a hydraulically driven vibrator, and a pneumatically driven vibrator.

8. The system of claim 1, wherein the conveyance comprises an enclosure through which the shear-thinning material is transported, the energizer comprising an energy propagation member which is positioned within the enclosure, wherein the energy propagation member is substantially surrounded by the shear-thinning material as the shear-thinning material is transported through the enclosure.

9. The system of claim 1, wherein the energizer comprises an enclosure through which the shear-thinning material is transported, the energizer imparting energy to the shear-thinning material as the shear-thinning material is transported through the energizer enclosure.

10. The system of claim 1, further comprising a controller, wherein the energizer is coupled to the controller, the controller providing one or more control signals to the energizer, the energizer adjusting a rate at which the energy is imparted to the shear-thinning material based on the control signals received from the controller.

11. The system of claim 10, further comprising one or more sensors which are coupled to the controller, the sensors sensing one or more conditions, generating sensor signals corresponding to the sensed one or more conditions, and providing the sensor signals to the controller, wherein the controller is configured to generate the control signals based on the received sensor signals.

12. The system of claim 11, wherein the one or more conditions comprise properties of the shear-thinning material.

13. The system of claim 12, wherein the sensed properties of the shear-thinning material comprise one or more of: fluidity, temperature, moisture.

14. The system of claim 11, wherein the one or more conditions comprise environmental properties.

15. The system of claim 14, wherein the sensed environmental properties comprise one or more of: temperature and humidity.

16. The system of claim 10, wherein the controller is configured to receive one or more manual inputs from a user, the controller adjusting the control signals based on the received manual inputs.

17. A method for increasing fluidity of a shear-thinning material during transit, the method comprising:
transporting a shear-thinning material from a material source to a destination; and
imparting energy to the shear-thinning material during the transporting of the shear-thinning material, the imparting of the energy increasing a fluidity of the shear-thinning material.

18. The method of claim 17, wherein the imparting of the energy comprises vibrating the shear-thinning material.

19. The method of claim 17, wherein the imparting of the energy is performed at a plurality of different locations in a transport path of the shear-thinning material, at least one of the plurality of locations being intermediate to a source end of the transport path and a destination end of the transport path.

20. The method of claim 19, wherein at least one of the plurality of locations is at the destination end of the transport path.
